(19) United States
(12) Patent Application Publication
(10) Pub. No.: US 2004/0265765 A1
(43) Pub. Date: Dec. 30, 2004

(54) Local exhaust system for VOC pollution control

(76) Inventors: Wei Ming Hsin, Taichung (TW); Tang Szu Wei, Taichung (TW); Hsieh Hsin Se, Changhua (TW)

Correspondence Address: PERKINS COIE LLP, PATENT-SEA, P.O. BOX 1247, SEATTLE, WA, 98111-1247, US

(21) Appl. No.: 10/646,665

(22) Filed: Aug. 21, 2003

(30) Foreign Application Priority Data
Jun. 10, 2003 (TW) 92115764

(51) Int. Cl. F27D 17/00; F23J 1/00

(52) U.S. Cl. 432/67

(57) ABSTRACT

A local exhaust system for volatile organic compound (VOC) pollution control comprises a plurality of hoods, pipelines, and airflow regulators. The plurality of hoods at one side of an article and around thereof and air flows at the other side to remove VOC thereon to generate polluted air flow such that the plurality of hoods receives and collects the polluted air. The plurality of pipelines connected to the plurality of hoods is to take the polluted air therefrom. The plurality of airflow regulators on the plurality of pipelines is to adjust air flow therein.

### CROSS-REFERENCE TO RELATED APPLICATIONS

This application claims the benefit of Taiwan Patent Application No. 92115764, filed Jun. 10, 2003, which is hereby incorporated by reference in its entirety.

### TECHNICAL FIELD

This invention relates to a local exhaust system, and more particularly to a local exhaust system for volatile organic compound (VOC) pollution control.

### BACKGROUND

In the semiconductor process or the photo-electric process, devices must be placed in a clean room, wherein the devices may be silicon wafers, wafers of groups III and V, or glass (plastic) substrates of LCD (Liquid Crystal Display). The substrates unavoidably generate pollutants during the process. If the pollutants adhere to the substrate after the process, the substrates can be cleaned with wet cleaning or dry cleaning. If the pollutants are volatile, the pollutants pervade in a chamber and are removed with air flow in the chamber in general.

However, the pollutants can be unhinderedly removed out of the chamber or the clean room. A coat of the pollutant will gradually be formed on the wall of the clean room or apparatuses thereof. Hence, the apparatuses must be checked and maintained periodically and so the operating time of the apparatuses will be shortened.

One solution for the problem is to remove some specific volatile pollutants by hoods when the apparatuses are stopping to maintain. But, when the apparatuses are operating, the volatile pollutants can not be remove.

Another solution for the problem is to place a local exhaust system in the chamber or in the clean room, wherein the local exhaust system comprises hoods and pipelines. The hoods and the pipelines are indispensable to the local exhaust system of industrial ventilation. Bad influences on users and apparatuses can be reduced to the least with a good layout. The conventional local exhaust system increases the exhaust speed of the hoods for exhausting more pollutants. However, a required stability of airflow environment for apparatuses in the high-technology industry can not be achieved. A non-uniform airflow not only decreases the efficiency of exhaust, but also the yield of products resulted from harming the airflow environment.

Accordingly, as aforementioned, the conventional local exhaust system for the high-technology industry has essential defects that must improve.

Hence, the inventors consider that the aforementioned defects can be improved and then bring up a layout to improve the defects according to theory and research.

### SUMMARY

In those conventional arts, the conventional local exhaust system has essential defects. One of objectives of the present invention is to provide a local exhaust system for volatile organic compound (VOC) pollution control. The local exhaust system can be employed to solve the problem that the conventional local exhaust system used in the high-technology industry cause airflow environment to become non-uniform and so the yield of products is decreased. Therefore, the present invention provides the local exhaust system that does not harm the stability of airflow environment and simultaneously maintain the efficiency of exhaust.

Another objective of present invention is to employ the environment characteristic of downward vertical laminar flow in the clean room and a layout of hoods that the dimension of openings gradually reduces. When the operating is normal, the hoods can collect the polluted downward airflow directly and uniformly, and air flow regulators in pipelines control the flow rate to balance the wind velocity at the openings for reducing the effect to the airflow environment and the yield.

Another objective of present invention is to provide a local exhaust system that avoids the aforementioned defects and maintain the efficiency of exhaust simultaneously during producing process of products.

Another objective of present invention is that hoods using for operating apparatuses and the operations of the hoods and the apparatuses are independent.

Another objective of present invention is that the hoods can efficiently collect vapor of organic solution with 90% collecting efficiency for reducing the leak in the environment.

Another objective of present invention is to maintain uniform airflow around a substrate for providing a stable quality of the process.

As aforementioned, the present invention provides a local exhaust system for volatile organic compound (VOC) pollution control comprises a plurality of hoods, pipelines, and airflow regulators. The plurality of hoods at one side of an article and around thereof and air flows at the other side to remove VOC thereon to generate polluted air flow such that the plurality of hoods receives and collects the polluted air. The plurality of hoods has a vertex angle and so the combined shape of the plurality of hoods is similar to a shape of the article. An exhaust aperture in the vertex angle connects to the plurality of pipelines. A dimension of the plurality of hoods is the maximum at the exhaust aperture and gradually reduces far away from the exhaust aperture. The plurality of pipelines connected to the plurality of hoods is to take the polluted air therefrom. The plurality of airflow regulators on the plurality of pipelines is to adjust air flow therein.

### BRIEF DESCRIPTION OF THE DRAWINGS

FIG. 1 is a schematic diagram of the local exhaust system of the present invention applied to collect VOC;

FIG. 2 is a schematic diagram of the hoods of the local exhaust system applied to the glass substrate process of the LCD;

FIG. 3 is a lateral view of the hoods of the local exhaust system applied to the glass substrate process of the LCD;

FIG. 4 is a vertical view of the hoods of the local exhaust system of the present invention; and

FIG. 5 is a schematic diagram of the hoods of the local exhaust system of the present invention.

### DETAILED DESCRIPTION

Some sample embodiments of the invention will now be described in greater detail. Nevertheless, it should be recognized that present invention can be practiced in a wide range of other embodiments besides those explicitly described, and the scope of the present invention is expressly not limited expect as specified in the accompanying claims.

The present invention mainly relates to a local exhaust system of collecting VOC for an apparatus that generates pollutants and is in a chamber. The local exhaust system of the present invention comprises a plurality of hoods, a plurality of pipelines, and a plurality of air flow regulators.

The plurality of hood at one side of an article around thereof and in the chamber, and air flows at the other side to remove VOC thereon to generate polluted air flow such that the plurality of hoods receives and collects the polluted air. Each hood is made from a container and one surface thereon is opening for collecting the polluted air. Each hood has a vertex angle and the hoods are combined with together to form a configuration similar to the shape of the article. An exhaust aperture at the vertex angle of each hood connects to each pipeline. The dimension of each hood is the maximum at the exhaust aperture and gradually reduces far away from the exhaust aperture. Each hood has a positioner.

The article may be a glass substrate. Therefore, the configuration of the combined hoods is rectangle and each hood has an exhaust aperture at the vertex angle and connects the pipeline. Furthermore, the article is supported by a support base that is among the plurality of hoods.

The plurality of pipelines connected to the plurality of hood is to take the polluted air therefrom. The plurality of pipelines that is inflexible and the caliber thereof is at least more than 5 cm is in the chamber and connects to an air-extracting apparatus.

The plurality of air flow regulator on the plurality of pipeline is to adjust air flow therein. Wherein the air flow regulator may be a damper.

In order that examiners further understand and recognize the objective, characteristic, and efficiency of the present invention, one preferred embodiment of the present invention is particularly illustrated with the drawings. As shown in FIG. 1, the local exhaust system 10 collecting VOC in the present invention comprises the hoods 12, the pipelines 14, and the air flow regulators 16. Wherein, the hoods 12 are connected with the below pipelines 14 through the exhaust apertures, respectively. The pipelines 14 are assembled with the air flow regulators 16. Finally, the pipelines 14 are connected with the primary pipelines 15 and connected to an air-extracting apparatus.

The main function of the hoods 12 is to collect or capture VOC. The air containing VOC are removed through the pipelines 14. Each air flow regulators 16 in the pipelines 14 can independently control the respective flow rate of air in the pipelines 14 and so this influences the collecting efficiency of the hoods 12. The pipelines 14 is inflexible for reducing the resistance to flow in the pipelines 14, and the caliber thereof is broadened for that a large number of air can uniformly flow in the pipelines 14. In the FIG. 1, in order to match with the layout of the apparatuses, the lengths of the four pipelines is not equal. Hence, for the hoods 12, the collecting efficiency s for the polluted air is not equal when the air flow regulators 16 is not operating. The main function of the air flow regulators 16 is to adjust the flow rates of the four independent pipelines 14 and so the collecting efficiency of each hood 12 for the polluted air is the same.

An article generating the pollutant is placed in the inner spaces composed by the hoods 12, e.g.: a manufacturing glass substrate or wafer. Wherein, the article is supported by a support base. In the embodiment, the article is a square substrate, and further may be a silicon wafer or a wafer of groups III and V. The space composed by the hoods 12 is conformed to the shape of the wafer. The amount of the hoods in the present invention is four, but really not limited to four. The amount of the hoods may be less than four when the hoods can achieve the function of collecting the polluted air. In the embodiment, each hood has an interval between the hood and the other hood. This is because of the embodiment is applied to the process of the glass substrate of liquid crystal display (LCD), and the chamber has support bases supporting the glass substrate and positioners fixing the position of the glass substrate. If the present invention is applied to other semiconductor process, OptoElectronics industry, or other processes that the present invention can applied to. The configuration of the hoods 12 depends on the applied apparatuses.

In the present invention, the air flow regulators 16 is first adjust to make the flow rates of the pipelines 14 be a certain ratio. This not only provides an enough exhaust volume, but also maintains the uniform airflow in the pipelines 14.

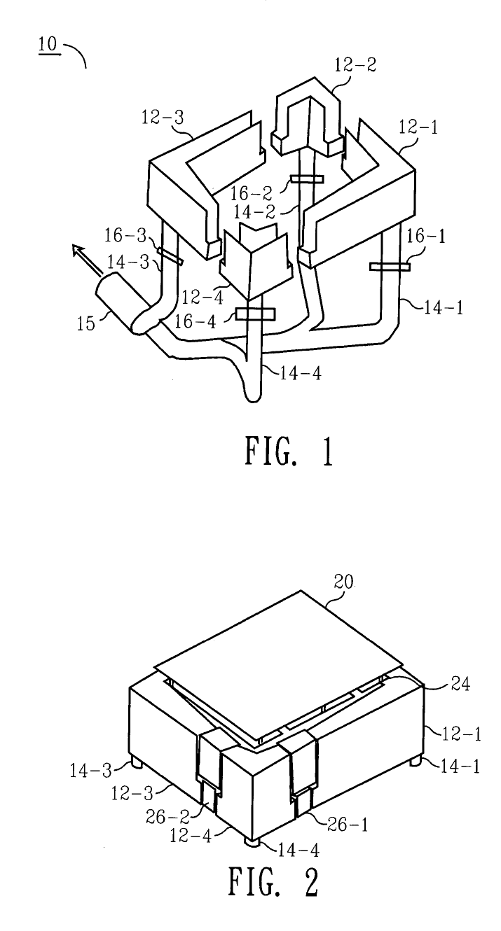

Referring to FIG. 2, it shows that the hoods 12 are assembled on the manufacturing apparatuses for LCD. Wherein the manufacturing apparatuses may be a deposition system, an etcher, a spin coater, or a photolithography system, eg: coater (ER) of TEL. In the embodiment, the article 20 is a glass substrate and the glass substrate is supported by the support base 24. The hoods 12 surround with the support base 24 and are fixed by the positioners 26 between the hoods 12. In the present invention, there are only the hoods 12 in the chamber, and the pipelines 14 are on the outside of the chamber. In general, the chamber is a clean room and downward clean air flows take away the pollutant on the article 20. In the aforementioned process, an organic solution was remained on the glass substrate in a former process or a organic polluted gas is remained on the glass substrate in the process. Therefore, the pollutants are generated on the entire glass substrate. These pollutants are removed through the downward air flows in the clean room. The present invention employs the air flow characteristic of the clean room and assembles the openings of the hoods 12 below the glass substrate 20 for directly collecting the polluted air.

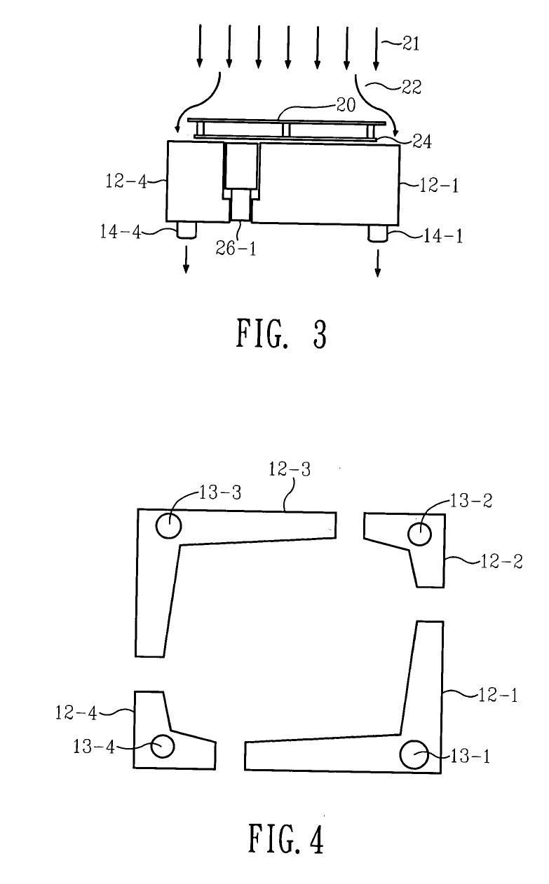

As shown in FIG. 3, the operating method of the present invention can be more clearly realized. The glass substrate 20 is supported by the support base 24. Each hood 12 has a positioner 26 between the hood 12 and the other hood 12 and connects to the below pipeline 14. On the glass substrate 20, the downward air flows of the clean room flow towards the glass substrate 20 and generates the polluted air 22 that is collected around the glass substrate 20 by the hoods 12. Then, the polluted air 22 through the pipelines 14 is removed away from the chamber. If the collecting efficiency of the hoods 12 need increasing, each air flow in the opening of each hood 12 must be equal and the flow rate also must be equal. The control method for the equal flow rate in the opening of each hood 12 is to employ the air flow regulator 16 and illustrated below.

FIG. 4 is a vertical view of the hoods 12, wherein each hood 12 has an exhaust aperture 13 for connecting to the pipeline 14. The dimension of the hood is the maximum at the exhaust aperture 13 and gradually reduces far away from the exhaust aperture 13. This can achieve the uniform collecting efficiency of a single hood 12. This is assume that the volume of the hood is not various on each position and so the flow rate of air far away from the exhaust aperture 13 is certainly slower, and so the air-extracting air flow is not uniform. Hence, the dimension far away from the exhaust aperture 13 gradually reduces for raising the collecting flow rate.

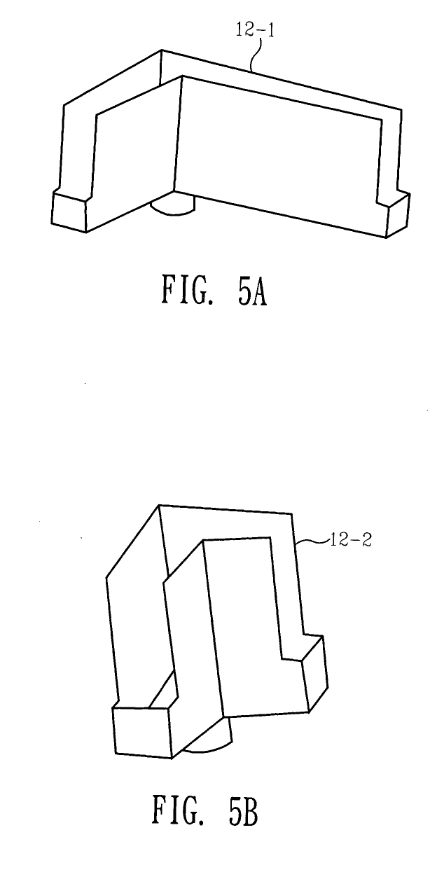

As shown in FIG. 5, it shows the configuration of different single hood 12. The size of each hood 12 can be not equal and has an opening in the position of collecting the polluted air, wherein an exhaust aperture is below the opening. Concave sections are between a hood and the other hood for matching with the layout of the positioners.

TABLE 1
the THC concentration (ppm) of the present invention

| Item\times | 1 | 2 | 3 | 4 | 5 | 6 | average |
|---|---|---|---|---|---|---|---|
| Below | 101.7 | 49.8 | 87.2 | 38.9 | 53.2 | 113.9 | 74.1 |
| substrate | | | | | | | |
| (pollutant) | | | | | | | |
| Environment | 2.9 | 3.2 | 4.1 | 4.4 | 3.9 | 4.5 | 3.9 |
| leak | | | | | | | |

TABLE 2
the THC concentration before and after the
present invention was employed

| item\times | 1 | 2 | 3 | 4 | 5 | 6 | average |
|---|---|---|---|---|---|---|---|
| before | 15.5 | 16.8 | 26.5 | 29 | 29.7 | 18.5 | 22.7 |
| (leak) | | | | | | | |
| after | 2.9 | 3.2 | 4.1 | 4.4 | 3.9 | 4.5 | 3.9 |
| (leak) | | | | | | | |

The present invention can be applied the hoods to a process system that is operating, and the hoods and process system have no interference with each other. The hoods can efficiently collect VOC to reduce the leak in the environment. Referring to Table 1 and Table 2, the collecting efficiency increases more than 90% compared with the conventional local exhaust system.

Furthermore, the hoods can maintain the uniform air flows around the substrate for providing a stable process quality.

The local exhaust system of the present invention comprises hoods and the exhaust pipelines connected with hoods. The present invention employs the characteristic of the downward air flow in the clean room and assembles the hoods below the pollutant for directly collecting the polluted air. In order to achieve the request for uniform flow rate, a dimension layout of gradual shrinking hoods and a air flow regulator that can adjust the air flow in the exhaust pipelines are added under the condition that the yield is not influenced.

Although specific embodiments have been illustrated and described, it will be obvious to those skilled in the art that various modifications may be made without departing from what is intended to be limited solely by the appended claims.

I/We claim:

1. A local exhaust system for VOC pollution control, said system comprising:
a plurality of hoods around at one side of an article and around thereof and air flows at the other side to remove VOC thereon and air flows at the other side to remove VOC thereon to generate polluted air flow such that said plurality of hoods receiving and collecting said polluted air;
a plurality of pipelines connected to said plurality of hood for taking said polluted air therefrom; and
a plurality of air flow regulators on said plurality of pipelines for adjusting air flow therein.

2. The system in claim 1, wherein said plurality of hoods is composed of a container and one surface of said container is opening for collecting said polluted air.

3. The system in claim 4, wherein said plurality of hoods has a vertex angle and the combined shape of said plurality of hoods is similar to a shape of said article.

4. The system in claim 5, wherein said plurality of hoods has an exhaust aperture in said vertex angle.

5. The system in claim 6, wherein a dimension of said plurality of hoods is the maximum at said exhaust aperture and gradually reduces far away from said exhaust aperture.

6. The system in claim 1, wherein positioners are among said plurality of hoods.

7. The system in claim 1, wherein said article is supported by a support base located among said plurality of hoods.

8. The system in claim 4, wherein said article is a glass substrate.

9. The system in claim 10, wherein a combined shape of said plurality of hoods is a rectangle.

10. The system in claim 1, wherein said plurality of pipelines is an inflexible pipeline.

11. The system in claim 1, wherein said plurality of pipelines connects to an air-extracting apparatus.

12. The system in claim 1, wherein said plurality of air flow regulator is a damper.

13. A local exhaust system for VOC pollution control applied to a apparatus that generates pollutants and is in a chamber, said system comprising:
a plurality of hoods around at one side of an article and around thereof and air flows at the other side to remove VOC thereon and air flows at the other side to remove VOC thereon to generate polluted air flow, wherein said plurality of hoods is composed of a container and one surface of said container is opening for collecting said polluted air, said plurality of hoods has a vertex angle, the combined shape of said plurality of hoods is similar to a shape of said article, said plurality of hoods has an exhaust aperture in said vertex angle, and a dimension of said plurality of hoods is the maximum at said exhaust aperture and gradually reduces far away from said exhaust aperture;
a plurality of pipelines connected to said plurality of hood for taking said polluted air therefrom; and
a plurality of air flow regulators on said plurality of pipelines for adjusting air flow therein.

14. The system in claim 13, wherein positioners are among said plurality of hoods.

15. The system in claim 13, wherein said article is a glass substrate.

16. The system in claim 15, wherein a combined shape of said plurality of hoods is a rectangle.

17. The system in claim 15, wherein said plurality of hoods has an exhaust aperture at a vertex angle of said rectangle connecting to said plurality of pipelines.

18. The system in claim 13, wherein said plurality of pipelines is inflexible.

19. The system in claim 13, wherein said plurality of pipelines connects to an air-extracting apparatus.

20. The system in claim 13, wherein said plurality of air flow regulator is a damper.
